(19) United States
(12) Patent Application Publication
(10) Pub. No.: US 2004/0048673 A1
(43) Pub. Date: Mar. 11, 2004

(54) Gaming device having alternating display

(76) Inventor: Joseph E. Kaminkow, Reno, NV (US)

Correspondence Address: BELL, BOYD & LLOYD LLC, P. O. BOX 1135, CHICAGO, IL, 60690-1135, US

(21) Appl. No.: 10/238,392

(22) Filed: Sep. 10, 2002

(51) Int. Cl. A63F 13/00

(52) U.S. Cl. 463/46

(57) ABSTRACT

A gaming device having a simulated or mechanical alternating display. The display includes a lever arm that pivots substantially at its middle about a pivot point. Each end of the lever arm points to one of a group of symbols placed on either side of the lever arm. When the lever arm moves, both ends point sequentially to the symbols of the group. An alternating indicator, such as a light placed on each side of the pivot point and adjacent to a respective one of the groups of symbols, indicates one of the groups of symbols. When the display finishes its sequence, the player is provided with the symbol from the group currently indicated by the indicator and currently indicated by the lever arm.

### BACKGROUND OF THE INVENTION

The present invention relates to gaming devices. More particularly, the present invention relates to wagering gaming device displays.

Gaming devices provide fun and excitement to the player. Gaming, in general, provides an escape from the everyday rigors of life. Gaming devices and gaming establishments use bright lights and exciting sounds to set gaming places such as casinos apart from the rest of the world. Gaming devices, in particular, use one or more displays that enable the player to see and play the game. The displays typically portray the action of the game and ultimately indicate whether or not the player wins or the amount a player wins.

Slot machine displays have gone through a number of transitions since their inception in the late 1800's. Originally, slot machines displayed purely mechanical reels. While these machines gained enormous popularity, the mechanical nature of the reels limited the number of paystops, which limited the number of different symbols and the number of different winning symbol combinations.

The advent of the computer and the video monitor expanded the possibilities for gaming devices. There are now video poker, video blackjack and other types of video gaming machines. Video displays have also been implemented in slot machines. The video slot machines use computers to randomly generate symbol combinations from an expanded number of different symbols. Video reel strips can include a virtually unlimited number of symbols, which enables a wide variety of different symbol combinations to be employed, including combinations that appear very infrequently and yield high payouts.

With slot machines, the video monitors have also been used to provide bonus or secondary games. Bonus games have become much more prevalent and elaborate in recent years. Players play the base game of slot until becoming eligible for or obtaining a triggering event for a bonus game. The base game temporarily pauses, while the player plays the bonus game. When the player completes the bonus game, the gaming device returns the player to the base game.

It should therefore be appreciated that a single video monitor is often sufficient to provide both the base game of slot and one or more bonus games that become triggered by the slot game. As seen in FIG. 1B, there is room on the gaming device 10b for an upper display area 32. This area, however, is often not used for gaming purposes and may simply provide a graphic such as a paytable and/or lettering that pertains to a theme of the gaming device.

Video monitors and in particular video-based slot machines are likely going to continue growing in popularity. As the video monitor has been used more and more, however, there has been a growing sentiment that some of the mystique of the old time mechanical gaming devices is lost when mechanical reels and mechanical displays are replaced by a video monitor.

Accordingly, a need exists to provide a gaming device that may use a video monitor, which provides increased flexibility to the gaming device to add more symbols and more elaborate bonus games, while providing some aspect of the gaming device that is mechanical and provides a fun and exciting mechanical display.

### SUMMARY OF THE INVENTION

The present invention provides a gaming device having a simulated or mechanical alternating display. The display includes a lever arm that pivots substantially at its middle about a pivot point. Each end of the lever arm points to one of a group of symbols placed on either side of the lever arm. When the lever arm moves, both ends point sequentially to the symbols of the groups. An alternating indicator, such as a light placed on each side of the pivot point and adjacent to a respective one of the groups of symbols, indicates one of the groups of symbols. When the display finishes its sequence, the player is provided with the symbol from the group currently indicated by the indicator and currently indicated by the lever arm.

In one embodiment of the present invention, the display includes an alternating indicator having a pivot arm that pivots about a pivot point. Each end of the arm includes an indicator that sequentially indicates one of a number of symbols in a symbol group. In this manner, the pivot arm is simultaneously indicating two symbols, one from each group of symbols associated with the dual ends of the pivot arm. The display also includes a group selection indicator that simultaneously indicates one of the groups, while the pivot arm simultaneously indicates one of the symbols from each of the groups. In an embodiment, the group selection indicator includes a light placed in association with each lever arm indicator. The group selection indicator selects one of the groups and the level arm indicators select one of the symbols of the groups, wherein the game ultimately provides the selected symbol from the group.

The group selection indicators can have various arrangements and can be any suitable type of visual highlighting device that indicates one group of symbols as opposed to another group. The display can have any suitable number of groups wherein the group selection indicator indicates one of three groups, four groups, etc. The display of the present invention can be simulated or electromechanical. Likewise, the group selection indicator can be simulated or electromechanical. In one embodiment the group selection indicator is a light, however, the group selection indicator can alternatively be a moving indicator, such as a lever arm.

The symbols represent various gaming device outcomes, such as game, credits, game credit multipliers, a number of picks from a prize pool, a number of free spins or free games, a progressive game increment, a symbol that enables the player to enter a bonus round or any combination of these. The symbol groups can include the same type of game outcomes or have various types of game outcomes as desired by the implementer. In one embodiment, the symbols are ordered from lowest to highest. In other embodiments, the symbols are randomly disbursed. The symbols of the groups are placed in such a manner than at certain times the lever arm indicators indicate a high value from one group and at the same time indicate a low value from another group. This creates excitement and enjoyment in the player who hopes to win the higher value. The group selection indicator, then alternates between higher and lower values.

Additional features and advantages of the present invention are described in, and will be apparent from, the following Detailed Description of the Invention and the figures.

### BRIEF DESCRIPTION OF THE FIGURES

FIGS. 1A and 1B are perspective views of alternative embodiments of the gaming device of the present invention.

FIG. 2 is a schematic block diagram of the electronic configuration of one embodiment of the gaming device of the present invention.

FIG. 3 is an elevation view of one embodiment of the present invention showing a lever arm indicating a first set of symbols.

FIG. 4 is an elevation view of the embodiment illustrated in FIG. 3 showing the lever arm indicating a second set of symbols.

FIG. 5 is an elevation view of the embodiments shown in FIGS. 3 and 4 showing the lever arm indicating a third set of symbols.

FIG. 6 is an elevation view of the present invention showing alternative groups of symbols from the groups illustrated in FIGS. 3 to 5.

FIG. 7 is an elevation view of the present invention showing various alternative group selection indicators than the group selection indicators illustrated in FIGS. 3 to 6.

### DETAILED DESCRIPTION OF THE INVENTION

The present invention provides a display and display indication that operate with the wagering games such as slot, poker, keno and blackjack. In an embodiment, the display and indicators operate in conjunction with bonus games, which in turn operate in conjunction with one of the base games such as slot, poker, keno and blackjack. Besides the base and bonus games of slot, poker, blackjack or keno, the present invention can operate with any primary game or with any of the bonus triggering events associated with primary games, as well as any progressive game coordinating with these base or bonus games. The symbols and indicia used for any of the base, bonus and progressive games include mechanical, electrical or video symbols and indicia.

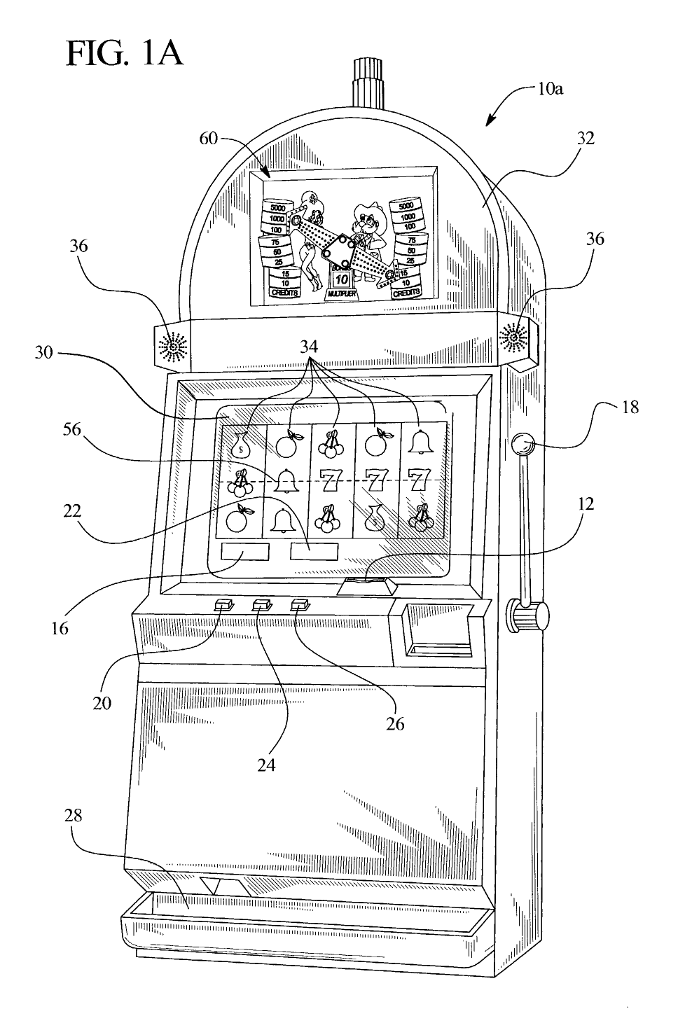

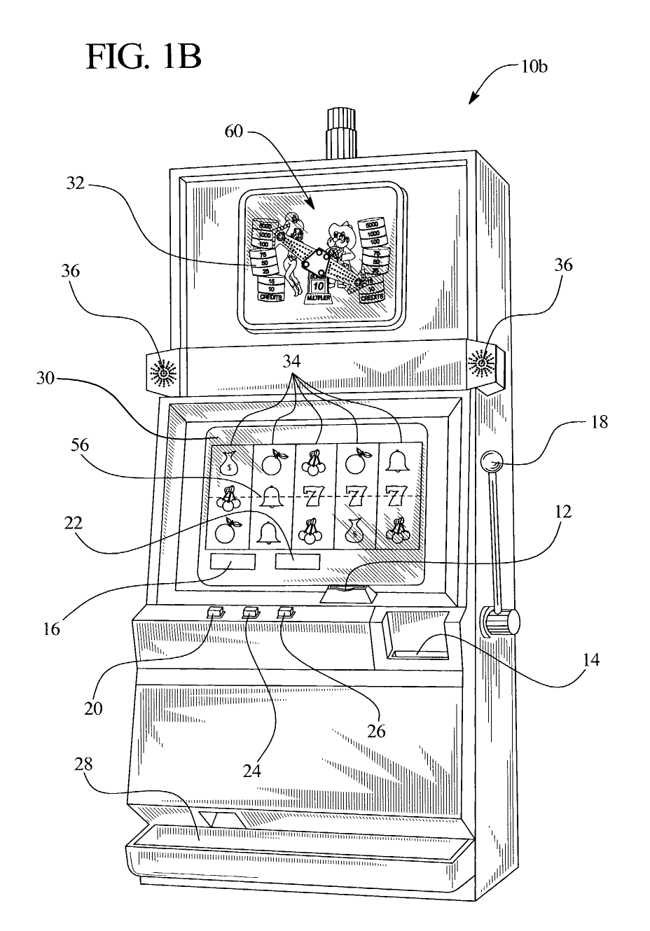

One primary embodiment for the display and display indicators is with the game of slot. Referring now to the drawings, and in particular to FIGS. 1A and 1B, one slot machine embodiment is illustrated. Gaming devices 10a and 10b illustrate two possible cabinet styles and display arrangements and are collectively referred to herein as gaming device 10. Gaming device 10 is illustrated as having the controls, displays and features of a conventional slot machine, wherein the player operates the gaming device while standing or sitting. Gaming device 10 also includes being a pub-style or table-top game (not shown), which a player operates while sitting.

Gaming device 10 includes monetary input devices. FIGS. 1A and 1B illustrate a coin slot 12 for coins or tokens and/or a payment acceptor 14 for cash money. The payment acceptor 14 also includes other devices for accepting payment, such as readers or validators for credit cards, debit cards or smart cards, tickets, notes, etc. When a player inserts money in gaming device 10, a number of credits corresponding to the amount deposited is shown in a credit display 16. After depositing the appropriate amount of money, a player can begin the game by pulling arm 18 or pushing play button 20. Play button 20 can be any play activator used by the player which starts any game or sequence of events in the gaming device.

As shown in FIGS. 1A and 1B, gaming device 10 also includes a bet display 22 and a bet one button 24. The player places a bet by pushing the bet one button 24. The player can increase the bet by one credit each time the player pushes the bet one button 24. When the player pushes the bet one button 24, the number of credits shown in the credit display 16 decreases by one, and the number of credits shown in the bet display 22 increases by one. A player may cash out by pushing a cash out button 26 to receive coins or tokens in the coin payout tray 28 or other forms of payment, such as an amount printed on a ticket or credited to a credit card, debit card or smart card. Well known ticket printing and card reading machines (not illustrated) are commercially available.

Gaming device 10 also includes one or more display devices. The embodiments shown in FIGS. 1A and 1B include a display device 30 and an upper display area 32. The display device includes any viewing surface such as glass, a video monitor or screen, a liquid crystal display or any other static or dynamic display mechanism. In a video poker, blackjack or other card gaming machine embodiment, the display device includes displaying one or more cards. In a keno embodiment, the display device includes displaying numbers.

The display and display indication of the present invention is provided, in an embodiment, in the area of the upper display area 32 of gaming device 10a and 10b of FIGS. 1A and 1B. The display and display indication of the present invention is provided, in another embodiment, on top of the rounded cabinet of gaming device 10a or rectangular cabinet of gaming device 10b. In a further embodiment, the top portion or “top box” of the gaming device is removed, creating a lower profile machine. Here, the display and display indication of the present invention sits on top of gaming device 10 but is lower to the ground than if the top box is not removed.

The slot machine embodiment of gaming device 10 includes a plurality of reels 34, for example three to five reels 34. Each reel 34 includes a plurality of indicia such as bells, hearts, fruits, numbers, letters, bars or other images which correspond to a theme associated with the gaming device 10. If the reels 34 are in video form, the display device displaying the video reels 34 is, in one embodiment, a video monitor. Gaming device 10 includes speakers 36 for making sounds or playing music.

With reference to the slot machine base game of FIGS. 1A and 1B, to operate the gaming device 10, the player inserts the appropriate amount of tokens or money in the coin slot 12 or the payment acceptor 14 and then pulls the arm 18 or pushes the play button 20. The reels 34 then begin to spin. Eventually, the reels 34 come to a stop. As long as the player has credits remaining, the player can spin the reels 34 again. Depending upon where the reels 34 stop, the player may or may not win additional credits.

In addition to winning base game credits, the gaming device 10, including any of the base games disclosed above, also includes bonus games that give players the opportunity to win credits. The gaming device 10 employs a video-based display device 30 or 32 for the bonus games. The bonus games include a program that automatically begins when the player achieves a qualifying condition in the base game.

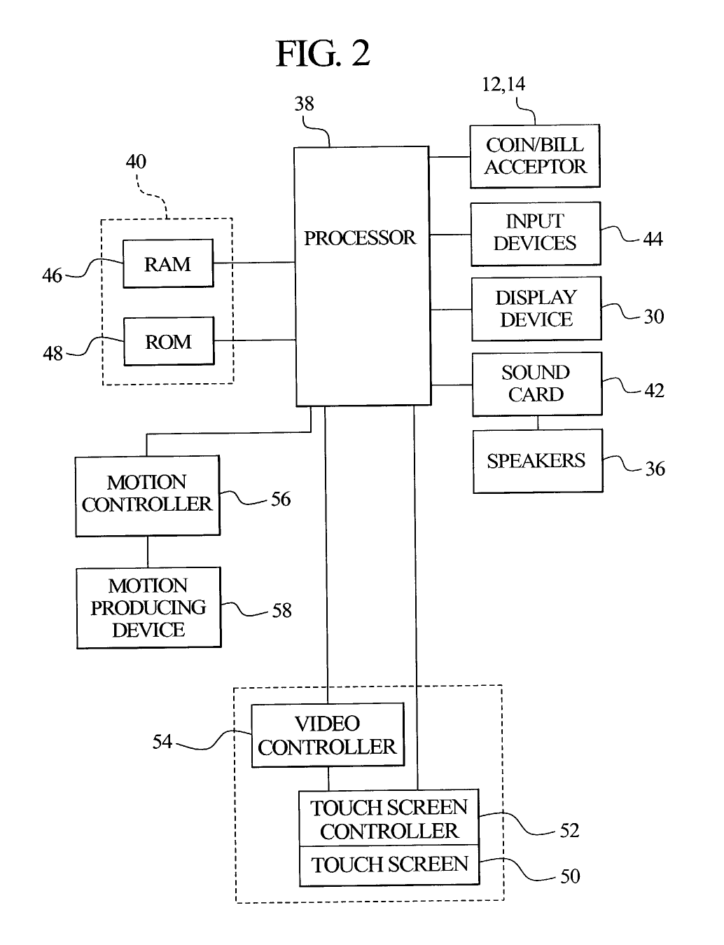

Referring now to FIG. 2, one embodiment of an electronic configuration for gaming device 10 includes: a processor 38; a memory device 40 for storing program code or other data; a display device 30; a sound card 42; a plurality of speakers 36; and one or more input devices 44. The processor 38 is a microprocessor based platform that is capable of displaying images, symbols and other indicia such as images of people, characters, places, things and faces of cards. The memory device 40 includes random access memory (RAM) 46 for storing event data or other data generated or used during a particular game. The memory device 40 also includes read only memory (ROM) 48 for storing program code, which controls the gaming device 10 so that it plays a particular game in accordance with applicable game rules and pay tables.

As illustrated in FIG. 2, the player uses the input devices 44 to input signals into gaming device 10. In the slot machine base game, the input devices 44 include the pull arm 18, play button 20, the bet one button 24, the cash out button 26 and other player inputs. A touch screen 50 and touch screen controller 52 are connected to a video controller 54 and processor 38. The touch screen enables a player to input decisions into the gaming device 10 by sending a discrete signal based on the area of the touch screen 50 that the player touches or presses. As further illustrated in FIG. 2, the processor 38 connects to the coin slot 12 or payment acceptor 14, whereby the processor 38 requires a player to deposit a certain amount of money to start the game.

The processor 38 also controls the output of one of more motion controllers 56 that control one or more actuators or motion producing devices 58. The motion producing devices 58 can be any combination of motors, stepper motors, linear stepper motors or other types of linear actuators. The motion controllers 56 typically include printed circuit boards or stand alone enclosures that receive high level commands from the processor 38. The motion controller 56 converts the high level commands, for example, into a number of step pulses, which in turn are converted into motor currents. The stepper motor or other type of motion producing device 58 receives the currents, wherein the currents cause, for example, a rotor to turn within a stator a precise and desired amount.

As described more fully below, the rotational motion of an actuator or motor 58 can be used to rotate a portion of the display or indicator of the present invention. The rotational motion can alternatively be converted to cause a portion of the display or indicator to translate. Otherwise, a linear motion producing device 58 can be used to directly cause a portion of the display or indicator of the present invention to translate.

The motion control arrangement facilitates complex movements of multiple parts to be programmed into the memory device 40 and carried out by the processor 38 at the appropriate time in the sequence of the game, be it a base, bonus, bonus triggering or progressive sequence of gaming device 10. Moreover, multiple programs can be implemented in the memory device 40, wherein the processor runs the appropriate program at the appropriate time, and wherein the displays and indicators described below can perform or move differently, e.g., faster, slower or in different directions at different times or points in the game. The motion control programs, in an embodiment, interface with one or more random generation devices, typically software based items, to produce randomly displayed outcomes on the displays and indicators of the present invention.

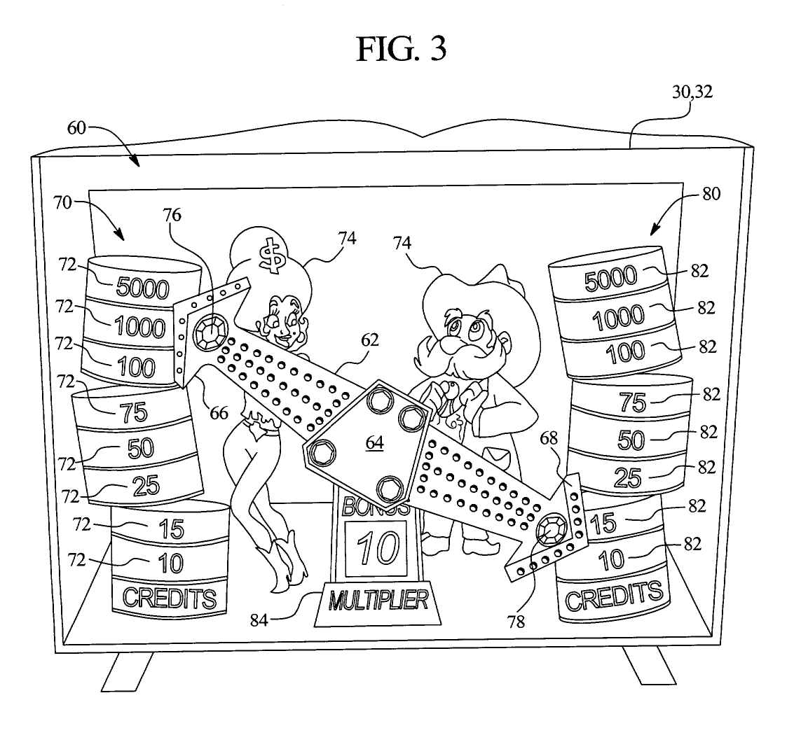

Referring now to FIG. 3, a display 60 illustrates one embodiment of the present invention. The display 60 in an embodiment appears on a video monitor, such as the display device illustrated in connection with FIGS. 1A and 1B. In another embodiment, display 60 is electromechanical, where, for example, display 60 appears on the upper display area 32 of gaming device 10 illustrated in FIGS. 1A and 1B. Display 60 can therefore be simulated or have actual physical parts.

Display 60 includes a lever arm 62 that pivots about pivot point 64. Lever arm 62 includes an indicator 66 at one end and an indicator 68 on the opposing end. In the illustrated embodiment, indicators 66 and 68 have the shape of an arrowhead or pointer, however, indicators 66 and 68 can have any suitable desired shape. It should also be appreciated that more than two indicators may be employed in the present invention.

The indicators 66 and 68 each indicate a respective group of symbols. Indicator 66 indicates symbols 72 from the group 70. Indicator 78 indicates symbols 82 from the group 80. The groups 70 and 80 of symbols 72 and 82, respectively, are positioned on either side of the pivot point 64. In the illustrated embodiment, the pivot point 64 is positioned roughly half-way between the groups 70 and 80. In an alternative embodiment, pivot point 64 is located closer to one of the groups 70 or 80.

The symbols 72 of the group 70 are spaced apart from one another in substantially a column. Likewise, symbols 82 are also spaced apart from one another substantially in a column. In an embodiment, pivot point 64 is located approximately in the center of the spaced apart distance of the columns of symbols of the groups 70 and 80. In an alternative embodiment, the pivot point 64 is positioned closer to one end of each of the columns of the groups 70 and 80.

In the illustrated embodiment, the pivot point 64 is roughly in the center of the symbol groups 70 and 80. For this reason, the arm length for the indicators 66 and 68 is approximately equal. If the pivot point 64 resides closer to one of the groups 70 or 80 and/or resides closer to one end of the column of symbols of the groups 70 and 80, the arm length of the indicators 66 and 68 of the lever arm 62 varies accordingly.

The display 60 in an embodiment includes a theme that corresponds to a theme of gaming device 10. In the illustrated embodiment, the theme is that of an oil tycoon, wherein display 60 includes indicia, figures, objects or other items 74 that relate to the gaming device theme.

The display 60 includes a group selection indicator that highlights or selects, at a given point in time, one of the groups 70 or 80 of symbols 72 and 82, respectively. In the illustrated embodiment, the group selection indicator is shown by lights 76 and 78 that are placed on the lever indicators 66 and 68, respectively. The lights 76 and 78 therefore move with the lever indicators 66 and 68. In an embodiment, the lights 76 and 78 alternate to show the player that the player is going to win one of the awards or be awarded one of the symbols 72 or 82, whichever is ultimately indicated by one of the lights 76 or 78.

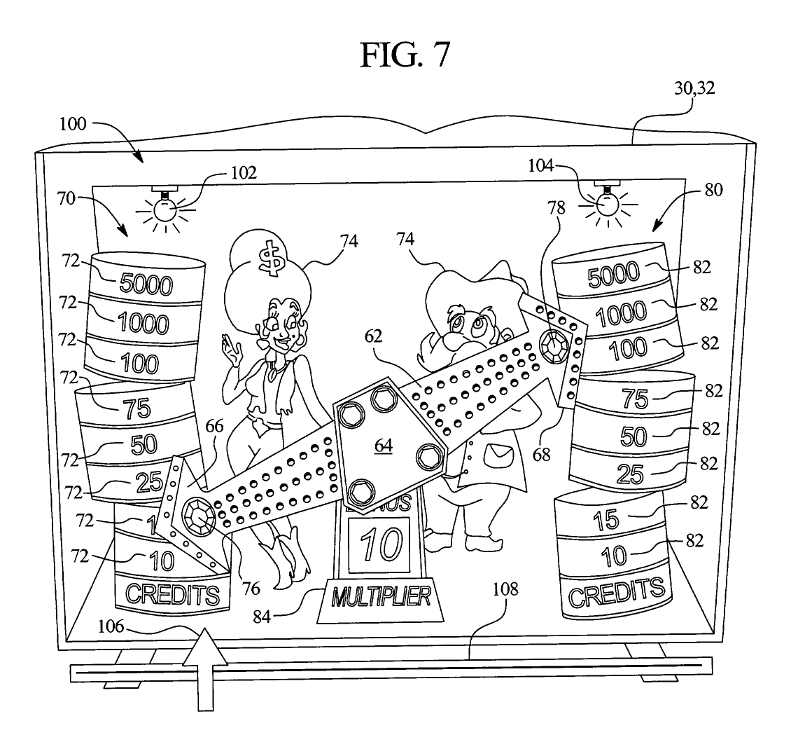

The group selection indicator can take on many different forms, some of which are illustrated below in connection with FIG. 7. For example, in an embodiment where display 60 resides on a video monitor or video display device 30, the group selection indicator can be: (i) an arrow that points alternatingly towards one of the groups 70 or 80; (ii) any type of light or highlighting adjacent to or associated with one of the groups 70 or 80; (iii) an indication by one of the theme objects 74; and (iv) any combination thereof.

The symbols 72 and 82 can represent a number of outcomes commonly associated with gaming devices. In the illustrated embodiment, symbols 72 and 82 are gaming device credits. In an alternative embodiment, one, a multiple of or all of the symbol 72 and/or 82 can be: (i) a multiplier of gaming device credits: (ii) gaming device symbols that alone or in combination with at least one other gaming device symbol yield a gaming device award; (iii) a number of picks from a prize pool; (iv) a progressive game increment; (v) a number of free games; (vi) a number of free spins; (vii) a symbol that signals an entry into a bonus game; and (viii) any combination thereof.

The symbols 72 and 82 make up at least part of an outcome provided by gaming device 10. In an embodiment, the gaming device 10 simply provides the symbol or credit value to the player, wherein gaming device 10 increments the credit meter 16 (FIGS. 1A and 1B) accordingly. In another embodiment, gaming device 10 alters or modifies the symbol in some fashion to provide an ultimate award to the player. For example, display 60 includes a meter 84 that illustrates a multiplier value. In an embodiment, gaming device 10 multiplies one of the symbols that is indicated by one of the lever arm indicators 66 and 68 and by one of the group selection indicators 76 and 78. The multiplier and the indicated symbol are multiplied to produce an ultimate award for the player.

The credit symbols are placed in ascending order in the illustrated embodiment. In the illustrated embodiment, both groups 70 and 80 include the same symbols that are in the same order. In this manner, when indicator 66 indicates the highest value of five thousand in the group 70, the alternative indicator 68 indicates the lowest valued symbol of ten in the group 80. A player viewing the display 60 of FIG. 3 obviously wishes to obtain the award currently indicated in the group 70 rather than the award currently indicated in the group 80. This disparity between awards creates tension and excitement for the player viewing the display 60. That is, if the order of the value of the symbols were reversed in one of the groups 70 or 80, the indicators 66 and 68 would indicate the same value, rendering the selection between the group 70 and 80 meaningless. In alternative embodiments, groups 70 and 80 do not have to have the same symbols, and to the extent that groups 70 and 80 have the same symbols, groups 70 and 80 do not have to place the symbols in the same order or in any particular order.

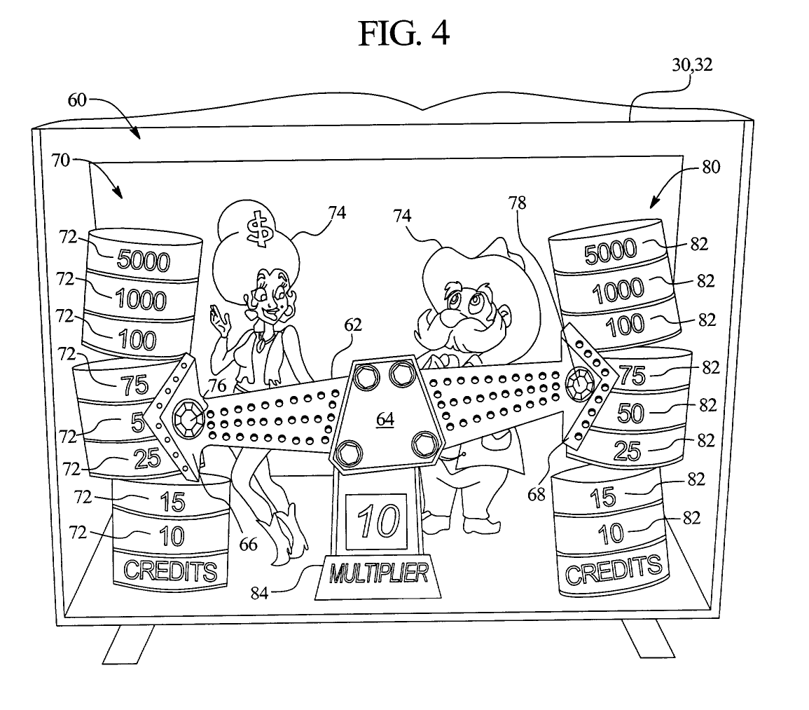

Referring now to FIG. 4, the lever arm 62 of the display 60 has rotated so that the indicators 66 and 68 at the end of the lever arm 62 are indicating intermediately placed symbols 72 and 82, respectively. If the display 60 is simulated, the motion of the lever arm 62 about pivot point 64 is simulated by the display 30. If the display 60 if electromechanical, the motion of the arm 62 about the pivot point 64 is produced by the motion controller 56 and motion producing device 58 discussed above in connection with FIG. 2.

In an embodiment, motion producing device 58 is a motor, such as a rotational stepper, servo or dc motor. Stepper motors in particular are common in gaming devices because they can be obtained in relatively small sizes, are programmable and are highly accurate. The stepper motor is controlled by a motor controller 56 which receives high level commands from the processor 38. The processor 38 runs a program that causes the lever arm 62 at a designated time to oscillate back and forth about pivot point 64 in a desired manner, and continue oscillating at any practicable, desired acceleration and velocity. After the pivot arm 62 stops rotating and indicates, via indicators 66 and 68, one of the symbols 72 and 82 from the groups 70 and 80, respectively.

The mechanical display 60 includes in one embodiment a positional feedback device, such as an encoder or a position sensor that sends a feedback signal to the processor so that processor 38 knows the location of the indicators 66 and 68 of the lever arm 62 at all times. By knowing the location of the indicators 66 and 68, gaming device 10 knows which of the symbols 72 and 82 is being indicated at any point of time. Gaming device 10 also knows which group 70 or 80 is being indicated by one of the group selection indicators 76 or 78 that enables the processor 38 to determine which of the symbols 72 and 82 indicated by the indicators 66 and 68, respectively, is to be used for a gaming device outcome.

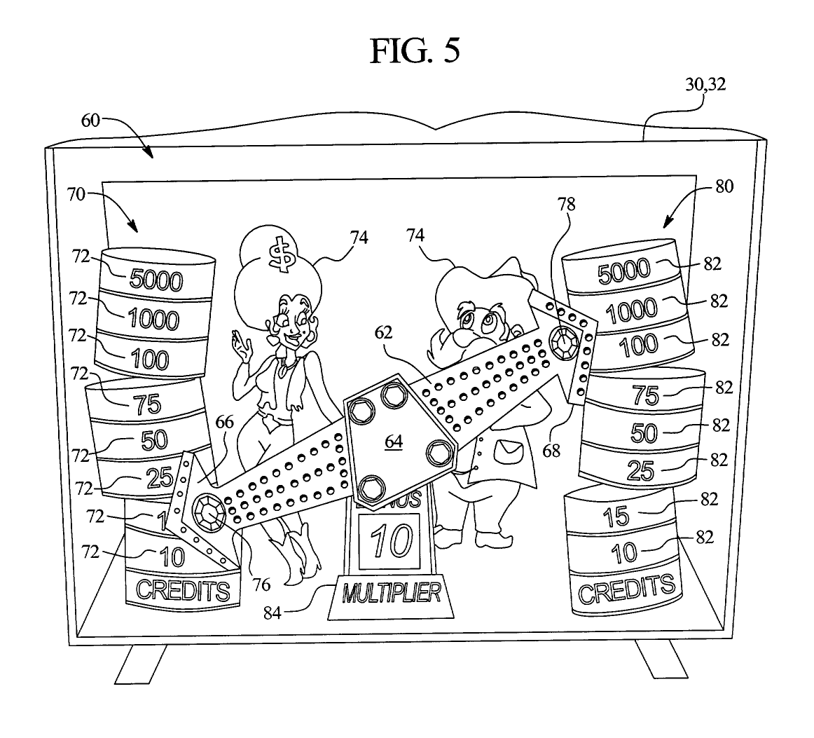

Referring now to FIG. 5, the indicator 62 has pivoted to almost the reverse position of the lever arm in FIG. 3. Here, indicator 66 indicates the second lowest symbol 72 in the group 70, and the indicator 68 indicates simultaneously the second highest symbol 82 in the group 80. During the oscillation shown in FIGS. 3 to 5, gaming device 10 in an embodiment alternates the lights 76 and 78, thereby altering whether the group 70 or the group 80 is indicated.

It should be appreciated that display 60 includes two random generation elements. The first random generation element is which symbol 72 or 82 from the respective groups 70 or 80 is indicated by the respective lever arm indicators 66 and 68, respectively. The second random element is whether the group selection indicators 76 and 78 are indicating the group 70 or the group 80. In FIG. 5, because the indicator 68 indicates the symbol 82 of one thousand and the indicator 66 indicates the symbol 72 of fifteen, the player desires that the group selection indicator 78 would select the group 80 at this moment.

In one embodiment of the present invention, one direction of movement is the active direction of movement, and one direction of movement is a non-active direction of movement. For instance, the movement of the member or lever in an upward direction can be the active direction and the movement of the member or lever in a downward direction can be the non-active direction. In one embodiment, the member or lever can only stop on a symbol or award when the member or lever is moving in an active direction such as upwardly.

It should also be appreciated that although the symbols or awards are illustrated in increasing magnitude from bottom to top, the symbols or awards could be in reverse order or in any suitable order such as a random order. It should also be appreciated that in one embodiment, probabilities are associated with the different symbols and the random determination of which symbols or awards are indicated is based on those probabilities. It should be appreciated that the probabilities may be the same or may be different.

After a predetermined period of oscillating the lever arm 62 about pivot point 64 and simultaneously changing whether the indicating light 76 or the indicating light 78 is lit, gaming device 10 stops the lever arm in a randomly generated position and stops the alternate changing of the lights 76 and 78 so that one light remains lit, which is also determined according to a random generation. The frequency that the lever arm oscillates with respect to the frequency that the indicating lights change is also determined by the game implementer and can be any practical, suitable frequencies. In one embodiment of the present invention, the lever arm could first stop to indicate opposing symbols and the indicating light could flash between choices and eventually stop to illuminate one side or group (even though the determination of the symbol could already be made). Alternatively, the indicating light could stop flashing and illuminate one side or group and the lever arm could keep moving until stopping to indicate one of the symbols in that group.

The random generations can occur at any point in the game program of gaming device 10 before the ultimate symbol is indicated by the display 60. In FIG. 5, for example, the processor 38 of gaming device 10 can determine prior to the lever arm 62 oscillating that the player receives the symbol 82 of one thousand from the group 80. According to this randomly generated outcome, gaming device 10 runs a sequence of oscillating the lever arm 62 and alternating the lights 76 and 78, ultimately culminating in the configuration illustrated in FIG. 5 with the indicator 68 pointing towards the symbol 82 of one thousand, and wherein the indicating light 78 is lit instead of the indicating light 76. Gaming device 10 then multiplies the credit value of one thousand by the multiplier of ten indicated by meter 84 to provide the player an ultimate award of ten thousand credits.

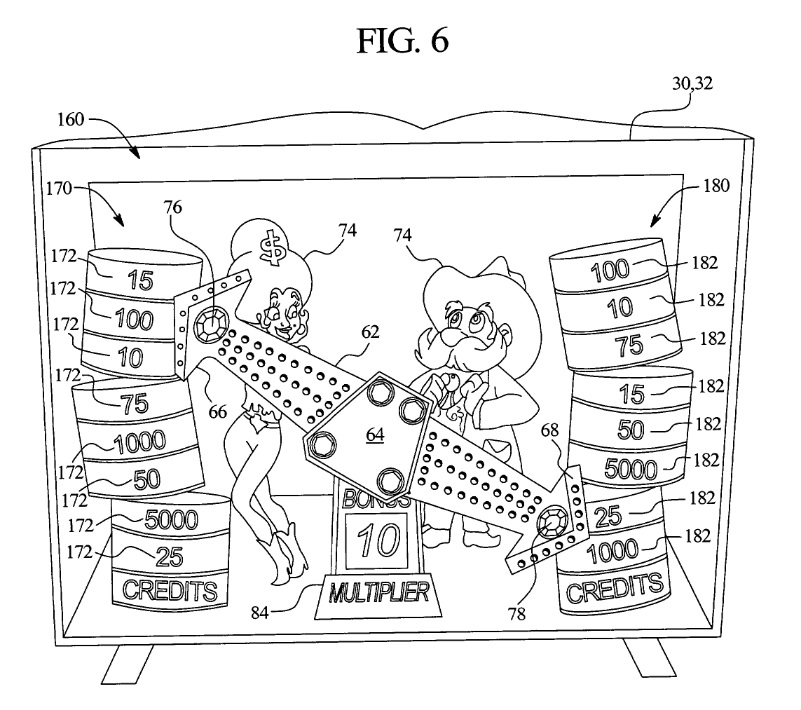

Referring now to FIG. 6, an alternative display 160 includes many of the same components of display 60 described above, including the lever arm 62 that rotates about pivot point 64 and has at its ends indicators 66 and 68. The alternative display 160 also includes the group selection indicators 76 and 78 placed at the ends of the pivot arm 62 along with the lever arm indicators 66 and 68, respectively. The alternative display 160 also includes the theme based objects and indicia 74 as well as the multiplier meter 84.

Display 160 includes alternative symbol groups 170 and 180. Alternative symbol group 170 includes symbols 172, while group 180 includes symbols 182. The symbols are again credits but could be any type of symbol described above. Symbols 172 and 182 include the same amounts as illustrated above with the display 60, however, the arrangement of the amounts is different. Display 160 illustrates a random amount distribution as opposed to an ordered distribution illustrated with the display 60. Although the amount distribution is randomly disbursed, the values are arranged in the alternative groups 170 and 180, such that one indicator will indicate the highest amount, while the other indicator will indicate simultaneously the lowest amount. The indicators 66 and 68 will simultaneously indicate medium amounts, etc. This distribution as stated above is desirable to create excitement in the player, wherein the player hopes to achieve a higher one of the two awards indicated.

The groups of the present invention, such as groups 170 and 180 do not have to be in a linear column as illustrated. The symbols 172 and 182 of the groups 170 and 180, respectively, can be distributed so that the groups have one or more curvatures. Further, any practical and suitable number of groups may be provided, and the present invention is expressly not limited to providing only two groups. Also, different groups can have different numbers of symbols. Still further, a portion of the motion sequence of the lever arm 62 could include the lever 62 turning at least one hundred eighty degrees in one direction so that indicator 68 indicates one of the symbols 172 over the group 170, while the indicator 66 indicates one of the symbols 182 of the group 180.

Referring now to FIG. 7, a further alternative display 100 is illustrated. Alternative display 100 includes many of the same components from the displays 60 and 160, including the lever arm 62, the pivot 64, the theme based indicia 74 and the multiplier meter 84. The alternative display 100 includes the symbol groups 70 and 80 having symbols 72 and 82, respectively, as does the display 60. As with all embodiments in the present invention, display 100 in an embodiment is a simulated display on video monitor 30 or an electromechanical display which is located, for example, in the upper display area 32. Any of the embodiments in electromechanical form can also be placed on the top of gaming device 10, wherein the top box as it is well known in the art can be removed so that the displays of the present invention are on top of the machine but lower in overall height.

Alternative display 100 illustrates various alternative group selection indicators. As previously illustrated, the group selection indicators included alternating lights placed on the indicators 66 and 68. In an alternative embodiment one or more lights, highlights, lighted areas or any other type of visual indication device such as fading out and brightening, changing color, etc., is placed adjacent to the group 70. Here, stationary lighted indicators 102 and 104 are placed adjacent to the groups 70 and 80, respectively. Indicators 102 and 104 illustrate that the indication can be positioned anywhere that is indicative of a respective group and does not have to be located on or associated with the moving indicators 66 and 68.

In a further alternative embodiment, a second moving or mechanical indicator 106 can be provided to alternatively select one of the groups 70 or 80. Indicator 106 is illustrated as translating back and forth in a groove 108. Indicator 106 in an embodiment is coupled to a stepper motor, e.g., via a lead screw or linear actuator. The indicator 106 couples through the slot 108 to the stepper motor or other type of motion producing device 58, wherein the processor 38 sends high level commands from a computer program to the motion controller 56, which converts the commands into motor currents to send to the motion producing device 58. In this manner, the indicator 106 can have any practical desired acceleration, velocity and positional movements. Indicator 106 alternatingly translates in the embodiment illustrated. In an alternative embodiment, an indicator can be provided that pivots back and forth about a pivot point or it uses some other type of motion that produces an alternating indication of the groups 70 and 80.

In one preferred alternative embodiment of the present invention, the gaming device provides the player with multiple awards. The indicators sequentially indicate each award and credit the player with each indicted award. In one such embodiment, after each sequential activation, indication and payment of an award, for a brief period of time, the player does not know whether the indicators will be activated again. This provides an exciting and entertaining game for the players. In one further alternative embodiment, the gaming device can provide the player with both symbols or awards which are simultaneously indicated by the member or lever. This could be done on a random or predetermined basis.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A gaming device comprising:
a cabinet;
a plurality of groups of symbols displayed on an area of the cabinet;
a member positioned between the groups, said member having two ends, a pivot point and a plurality of different positions about said pivot point, wherein in said positions said end of the members simultaneously indicate one of the symbols from each of the different groups; and
at least one indicator that alternately indicates each of the different groups, wherein a game outcome is based, at a point in time, on at least one of the symbols from the group indicated by the indicator and indicated by one of the ends of the member.

2. The gaming device of claim 1, which includes an actuator positioned inside the cabinet and coupled to the member to pivot the member.

3. The gaming device of claim 1, wherein the area of the cabinet is a display device and the symbols and member are simulated by the display device.

4. The gaming device of claim 1, wherein the indicator includes a plurality of lights, each light positioned in proximity to a respective group of symbols.

5. The gaming device of claim 1, wherein the indicator includes a plurality of lights, each light positioned on one of the ends of the member.

6. The gaming device of claim 1, wherein the indicator includes a mechanical device.

7. The gaming device of claim 1, wherein the symbols are selected from the group consisting of: gaming device credits, a multiplier of gaming device credits, gaming device symbols that alone or in combination with at least one other gaming device symbol yield a gaming device award, a number of picks from a prize pool, a progressive game increment, a number of free games, a number of free spins, a symbol that signals an entry into a bonus game and any combination thereof.

8. The gaming device of claim 1, which includes a random generation of the indicated symbol.

9. The gaming device of claim 1, which includes a motion sequence including the member alternatingly pivoting about the pivot point a number of times and stopping at the point in time.

10. A gaming device comprising:
a cabinet;
a plurality of groups of symbols displayed on an area of the cabinet, wherein the symbols of each group are spaced apart from one another and the groups are spaced apart from one another;
a movable member positioned in a substantially central location with respect to the spaced apart symbols in the groups, said member movable to a plurality of different positions and including two ends, wherein each said end indicates one of the symbols of one of the groups in each of said positions; and
an indicator operable to alternatively indicate one of the groups, wherein a game outcome is based, at a point in time, on at least one of the symbols from the group indicated by the indicator and indicated by one of the ends of the member.

11. The gaming device of claim 10, wherein the symbols in each group are spaced apart substantially the same amount.

12. The gaming device of claim 10, wherein the groups are spaced apart in substantially parallel columns.

13. The gaming device of claim 10, wherein the member is positioned in a substantially central location with respect to said spacing between the groups.

14. The gaming device of claim 10, wherein in one of the position, one end of the member indicates a top most symbol in one of the groups and the other end of the member simultaneously indicates a bottom most symbol in another one of the groups.

15. A gaming device comprising:
a cabinet;
a plurality of groups of symbols displayed on an area of the cabinet, wherein the symbols of each group are spaced apart from one another and the groups are spaced apart from one another;
a movable member positioned in a substantially central location with respect to the spaced apart symbols in the groups, said member movable about a pivot point to a plurality of different positions and including two ends, wherein each said end indicates one of the symbols of one of the groups in each of said positions; and
an indicator operable to alternatively indicate one of the groups, wherein a game outcome is based, at a point in time, on at least one of the symbols from the group indicated by the indicator and indicated by one of the ends of the member.

16. A method of operating a gaming device comprising the steps of:
(a) displaying a plurality of spaced apart groups, each group including a plurality of awards;
(b) simultaneously indicating one of the awards from each of at least two of the groups;
(c) sequentially changing the simultaneous indication of the awards in the groups;
(d) sequentially indicating each of the groups;
(e) stopping the simultaneous indication of the awards from the groups to simultaneously indicate two of the awards from two different groups and stopping the sequential indication of each of the groups to indicate one of the groups; and
(f) providing the indicated award, if any, from the indicted group.

17. The method of claim 16, wherein sequentially changing the awards that are indicated further includes the step of indicating a highest award from one of the groups while indicating a lowest award from the other group.

18. The method of claim 16, wherein displaying the groups includes displaying the awards of the groups from highest to lowest.

19. The method of claim 16, wherein displaying the groups includes displaying the award randomly dispersed according to their amounts.

20. A gaming device comprising:
a plurality of groups of symbols, each group of symbols including a plurality of symbols;
a member having a plurality of different positions, wherein in each said position said member simultaneously indicates one of the symbols from each the different groups;
an indicator which is operable to indicate each of the groups;
a processor operable with the member and indicator to indicate one of the symbols in one of the groups by simultaneously causing (i) the member to sequentially move to the different position and (ii) the indicator to sequentially indicate the groups, and causing the member to stop at one of the positions and the indicator to indicate one of the groups.

21. The gaming device of claim 20, wherein in each said position said member simultaneously indicates opposing symbols from each of the different groups.

22. The gaming device of claim 20, wherein a plurality of the opposing symbols from each the different groups are inversely related.

23. The gaming device of claim 20, wherein the member pivots about a pivot point to simultaneously indicate one of the symbols from each the different groups.
